(19) United States
(12) Patent Application Publication
(10) Pub. No.: US 2012/0250935 A1
(43) Pub. Date: Oct. 4, 2012

(54) Method for Designating a Target for a Weapon Having Terminal Guidance Via Imaging

(75) Inventor: Etienne Payot, Voisins-Le-Bretonneux (FR)

(73) Assignee: THALES, Neuilly-sur-Seine (FR)

(21) Appl. No.: 13/516,729

(22) PCT Filed: Dec. 1, 2010
(86) PCT No.: PCT/EP2010/068662

§ 371 Date: Jun. 16, 2012

(30) Foreign Application Priority Data
Dec. 18, 2009 (FR) 09 06174

(51) Int. Cl. G06K 9/00

(52) U.S. Cl. 382/100

(57) ABSTRACT

A method for designating a target in an area, intended for a weapon having terminal guidance via imaging, by means of an airborne optronic system comprising an imager associated with geolocation means and a processing unit. It comprises the steps of: acquisition of an image of the area by the imager of the system, and geolocation of this image by the geolocation means; extraction from a database of an orthoimage of the geolocated area, called the reference virtual image; designation of the position of the target in the reference virtual orthoimage; extraction from the reference virtual orthoimage of primitives around the position of the target, called virtual primitives; determination of the position of the target with respect to these virtual primitives; transferring the virtual primitives and the position of the target to the weapon having terminal guidance via imaging.

The field of the invention is that of designating a target for a weapon having terminal guidance via imaging.

In order to achieve metric class hit precision, INS/GPS guided weapons, such as the AASM (Air-to-Ground Modular Weapon), use terminal guidance via imaging. During this terminal guidance phase, the weapon acquires images which it compares with reference data (called primitives) of the target and of its context and upon which it resets its trajectory.

It is recalled that the primitives are elements of the image upon which an automatic processing makes it possible to extract a characteristic item of geometric information of point, line or even area form such as a crossroads (point), a portion of road (line) or the contour of a field (area).

The present procedure consists of loading reference data constructed by an operator from information images (geometrically corrected satellite image, air reconnaissance, . . . ) into the guided weapon with terminal guidance via imaging during Mission Preparation (PMISS). This procedure does not however make it possible to process opportune targets and notably movable targets (or “Time Sensitive Targets”).

Another solution consists in constructing the primitives in flight. At present there are several ways of constructing these primitives:

from images coming from a radar used in SAR (Synthetic Aperture Radar) mode,

from optronic data,

by combining these two types of data.

The construction of primitives using radar data has the following disadvantages:

necessity, in order to achieve good resetting precision, of using a THR (Very High Resolution) mode, which is not operational at the present time,

large difference between the spectral band of the extracted primitives and that of the primitives used by the Homing Head,

difficulty of extracting primitives from an SAR image in an urban environment because of masking and interference echoes,

constraint on the trajectory of the carrier and on the acquisition and processing time in order to obtain a high resolution SAR image,

absence of discretion because of the necessity of illuminating the target by a radar.

The construction of primitives using optronic data is for example obtained as follows.

An image of the area where the target is located is generally acquired whilst being far from the target and therefore in oblique view. The primitives are extracted from this obliquely viewed image. Image processing is then applied to these primitives in order that they become “usable” by the weapon, notably by compensating for their geometric distortions related to the acquisition according to an oblique view. However, this processing of primitives has not been satisfactory up to the present time.

Moreover, the primitives constructed using optronic data have the following disadvantages:

the compromise between the field covered in order to have the context around the target so that the weapon can match with this context and the resolution in order to have good positioning of the primitives is difficult to achieve; techniques of construction of a mosaic of images in order to reconstruct a larger field have been considered but they require scanning around the target and the relative precision of the primitives can be marred by errors during this phase of construction of a mosaic;

the images are acquired in oblique view which does not correspond to the angle of approach of the weapon which is close to the vertical. The primitives extracted from the optronic image which correspond to vertical or high structures can interfere with the matching of the AD (Homing Head) because of the 3D perspective effects. At present there is no processing making it possible to identify these interfering primitives in order to be able to eliminate them.

The purpose of the invention is to overcome these disadvantages.

The method according to the invention is based on the use of a vertical virtual imaging approach for designating the position of the target. The line of sight of this virtual imaging approach is slaved to the optronic line of sight.

More precisely, the invention relates to a method for designating a target in an area, intended for a weapon having terminal guidance via imaging, by means of an airborne optronic system comprising an imager associated with geolocation means and a processing unit. It is principally characterized in that it comprises the steps of:

acquisition of an image of the area by the imager of the system, and geolocation of this image by the geolocation means,

extraction from a database of an orthoimage of the geolocated area, called the reference virtual image,

designation of the position of the target in the reference virtual orthoimage,

extraction from the reference virtual orthoimage of primitives around the position of the target, called virtual primitives,

determination of the position of the target with respect to these virtual primitives,

transferring the virtual primitives and the position of the target to the weapon having terminal guidance via imaging.

The extraction of the virtual primitives can be carried out by the processing unit or from a primitives database associated with the geolocated images database.

The virtual images database possibly also comprises metadata associated with the images and the extracted primitives are associated with these metadata.

According to a first implementation of the method according to the invention, it comprises a step of presentation of a reference virtual image to an operator.

The presented image can be the reference orthoimage; in this case, the step of designation of the target is carried out by the operator on this orthoimage and it comprises a sub-step of centering the reference image in order to obtain a virtual orthoimage centered on this position.

According to an alternative, the presented image can be the orthoimage projected according to the viewing conditions of the optronic image; in this case the step of designation of the position of the target comprises a sub-step of designation, by the operator, of the target in the projected image in order to obtain a projected virtual image centered on this position, and a sub-step of transformation of this centered projected virtual image into a centered virtual orthoimage.

According to another implementation of the method according to the invention, it furthermore comprises the following steps:

extraction of primitives from the acquired image, called acquired primitives,

matching of the virtual primitives and the acquired primitives,

enhancement of the virtual primitives by the acquired primitives and designation of the position of the target.

The invention also relates to an optronic target designation system equipped with an imager and connected to a weapon having terminal guidance via imaging. It is characterized in that it comprises geolocation means connected to the imager, a virtual images database and a processing unit capable of implementing the method as described above.

Other features and advantages of the invention will become apparent on reading the following detailed description, given by way of non-limiting example and with reference to the appended drawings in which:

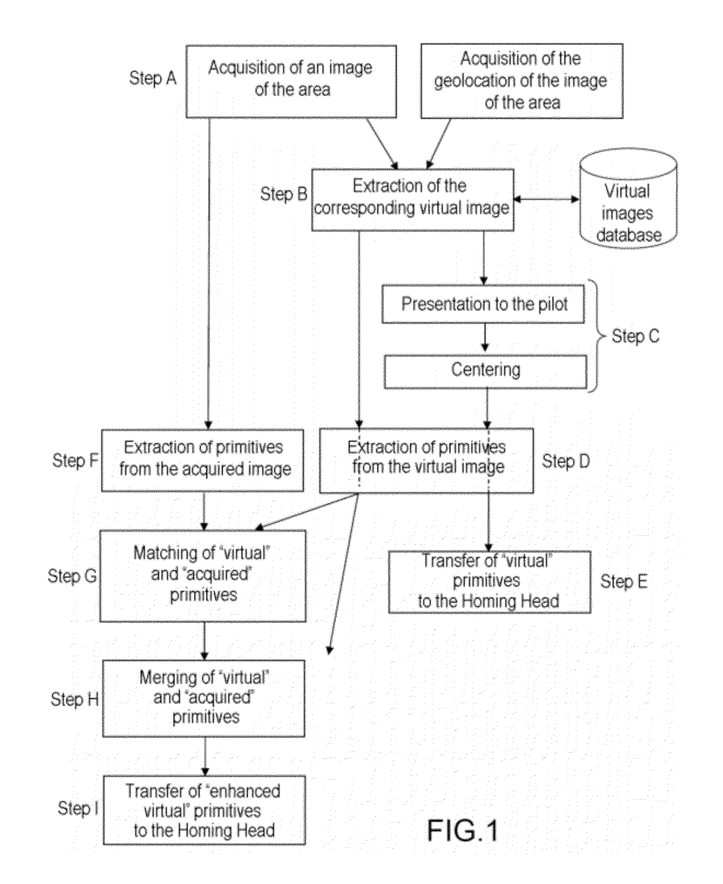

FIG. 1 shows a flowchart of the different steps of an example of the method according to the invention,

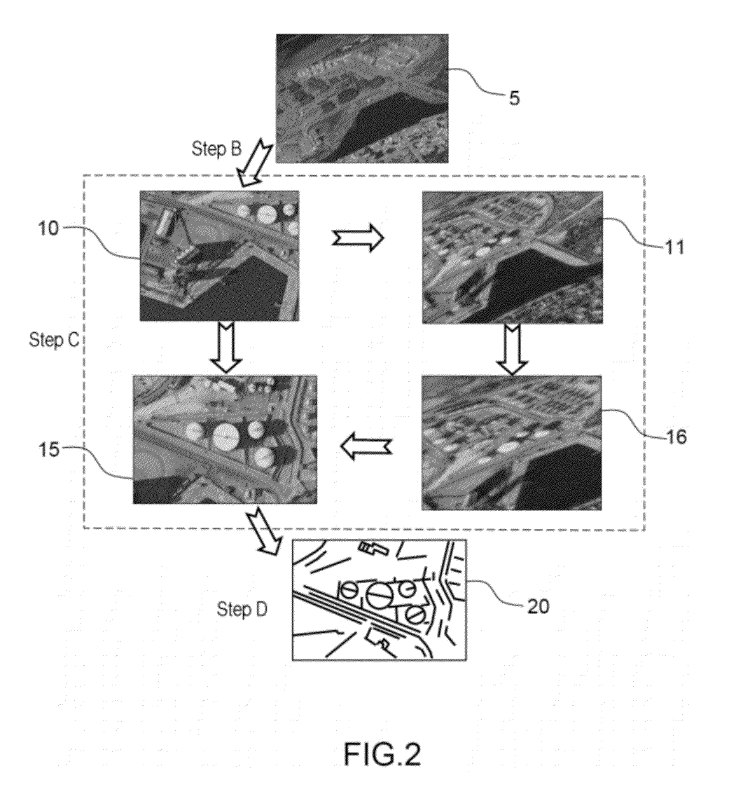

FIG. 2 is a diagrammatic illustration of two ways of displaying virtual images to the pilot, according to the invention,

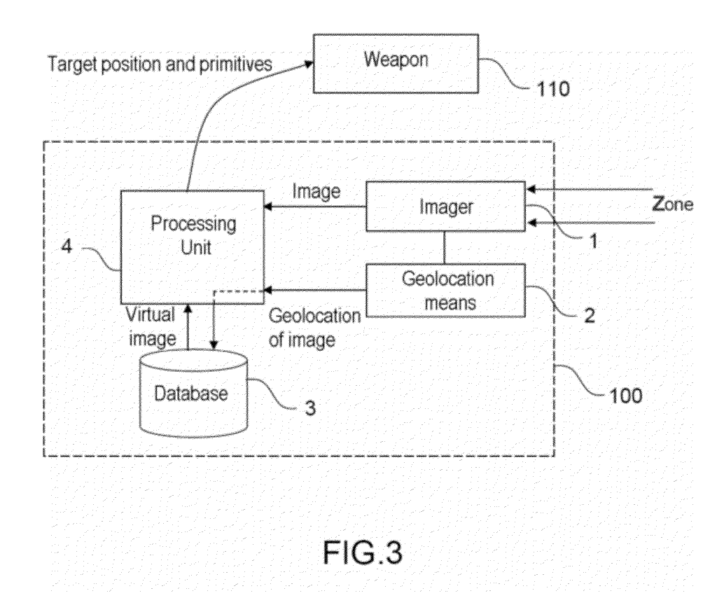

FIG. 3 is a diagrammatic representation of an example of an optronic designation system according to the invention.

The same elements are given the same references in each of the figures.

The method according to the invention is described with reference to the flowchart in FIG. 1 and with reference to FIGS. 2 and 3.

It comprises a step of acquisition of the image of the area in which the target is located; this acquisition is carried out by the imager 1 of the airborne system. This image 5 is geolocated by the geolocation means 2 associated with this imager (step A). This geolocation is preferably carried out with decametric precision.

On the basis of this geolocation, a virtual image 10 is extracted (step B) from a geolocated images database 3. This extraction corresponds to a windowing of an area of variable size. Preferably, the image is presented to the operator with a resolution close to that of the acquired image. The operator can, according to his requirement, carry out a zoom in the virtual image. This database is preferably installed in the airborne system 100; it is for example a satellite database. According to a variant, the virtual image 10 comes from an image previously acquired by the system or by another airborne system, this image also being geolocated and stored in a database.

This virtual image 10 is an orthoimage oriented according to the geographic viewing axes and with a scale consistent with that of the observed image; it is an image seen vertically.

The target is not necessarily present in this virtual imaging approach (for example in the case of a movable target) but the contextual elements which provide the primitives are so and can allow location.

The target or rather the position of the target is then designated on this virtual image. Different methods of designation of the target can be used.

In a manual mode shown in FIG. 2, an operator, who can be the pilot of the aircraft in which the system 100 is installed, manually designates the target in this virtual imaging approach. Depending on the pilot's choice, he is presented (step C) with, as a virtual image:

a. either the orthoimage 10 of the observed area as extracted;

b. or a re-projection 11 of the orthoimage according to the imager's viewing conditions. It is an oblique view image. In fact, the designation of the target on this image can be easier for the pilot when the virtual image presented to him is close to the image acquired in oblique view, which the orthoimage would not be: this method of presentation allows the pilot to more easily make the link between the acquired image and the virtual image which is presented to him. This re-projection is typically obtained by carrying out a geometric transformation of the homographic or affine map type.

On this virtual image (vertical view 10 or oblique view 11), the pilot designates the precise point of the position of the target.

In both cases, the center of the presented virtual image 10 or 11 is slaved to the position of the imager's line of sight; the virtual image is said to be centered 15 or 16 (step C). It is a manual centering (carried out by the operator).

The primitives (segments), called virtual primitives 20, are extracted from the reset virtual orthoimage (not re-projected) 15 (step D). There are many methods of extracting primitives in the image processing field and they can be used for carrying out this function. Some of them operate by thresholding the gradient of the image in order to extract the contours from it and then carry out “chaining” in order to represent these contours in the form of a set of segments or other geometric shapes (circle, ellipse, rectangle, . . . ). Other techniques replace the thresholding by a selection of peak lines or maximums of the image gradient level lines. Once extracted, these primitives are transferred to the weapon 110 with the position of the target with respect to the primitives of this orthoimage (step E). This transfer uses the communication hardware resources of the processing unit 4 and its interface with the carrier and the weapon. According to a variant, the virtual primitives 20 are pre-calculated on the orthoimages and stored for example in the virtual images database 3 whilst being associated with the corresponding virtual images.

In an automatic mode, the pilot does not intervene; the chaining of steps is as follows.

The virtual primitives 20 come from the orthoimage 10.

In parallel with steps B and D, primitives called acquired primitives are extracted directly from the acquired image 5 of step A which is generally an image acquired in oblique view (step F).

The virtual primitives 20 which come from the orthoimage 10 and the acquired primitives which generally come from the oblique view image, are matched (step G). This matching principally consists in spotting homologous pairs of acquired and virtual primitives (which correspond to each other), then in determining the transformation making it possible to change from the references of the acquired primitives to the “ortho” references of the virtual primitives. There are many techniques for carrying out this type of matching, for example the techniques using the ICP (Iterative Closest Point) algorithm which makes it possible to refine an initial matching calculated from geolocation data. Other approaches use the robust RANSAC (RANdom SAmple Consensus) statistical matching algorithm. The primitives thus matched are then merged (step H) in such a way as to enhance the virtual primitives 20. The designation of the target is carried out during these matching steps G and H-merging and centering the virtual primitives around the point designated by the pilot. This centering is possible after the matching of primitives between the acquired image and the virtual orthoimage.

These virtual primitives are then transferred to the weapon 110 with the position of the target with respect to these primitives.

The virtual and/or acquired primitives are preferably extracted with metric or even sub-metric relative precision (i.e. between primitives).

The method works better the more recent the virtual image is; modifications due to recent constructions or destructions can in fact generate inaccurate primitives.

It has several advantages:

it does not necessitate metric geometric referencing but only of the decametric class compatible with the envisaged performance because either the pilot designates the target manually or it is carried out by the resetting/merging with the primitives coming from the orthoimages;

the primitives are extracted from an orthoimage (vertical view) and do not therefore suffer from perspective effects which make the precise positioning of the primitives extracted in oblique view difficult; in the case where merging is carried out, these primitives extracted from the orthoimage make it possible to sort and select the relevant primitives;

in both the automatic and manual modes, the size of the area on which the primitives are extracted does not have to be limited to the area seen by the pilot; the field/resolution compromise constraint is therefore eliminated;

the resolution of the virtual image on which the designation is carried out and on which the primitives are extracted is not bound to the carrier/target distance and can therefore allow long range designation.

Possibly, the virtual images database 3 furthermore comprises metadata associated with the images. These metadata are for example constituted by masks making it possible to associate the nature of the corresponding object (road, field, forest, building, . . . ) with each pixel of the orthoimage. The extracted primitives are then associated with these metadata.

FIG. 3 shows an optronic system 100 capable of implementing the method according to the invention. It comprises an imager 1 equipped for example with a matrix detector and connected to image geolocation means 2 such as a GPS device associated with angular measurement means such as an inertial system. The geolocation is transmitted via a processing unit 4 to a virtual images database 3.

This processing unit 4 comprises means of implementing the method as described and means of transmission of the primitives and of the position of the target to the weapon 110 having terminal guidance via imaging.

1. A method for designating a target in an area, intended for a weapon having terminal guidance via imaging, by means of an airborne optronic system comprising an imager associated with geolocation means and a processing unit, further comprising:
acquisition of an image of the area by the imager of the system, and geolocation of this image by the geolocation means (step A),
extraction from a database of an orthoimage of the geolocated area, called the reference virtual image (step B),
designation of the position of the target in the reference virtual orthoimage (step C or steps G and H),
extraction from the reference virtual orthoimage of primitives around the position of the target, called virtual primitives (step D),
determination of the position of the target with respect to these virtual primitives,
transferring the virtual primitives and the position of the target to the weapon having terminal guidance via imaging (step E or I).

2. The method of designation of a target as claimed in claim 1, wherein the extraction of the virtual primitives is carried out by the processing unit or from a primitives database associated with the geolocated images database.

3. The method of designation of a target as claimed claim 1, wherein the virtual images database also comprises metadata associated with the images and in that the extracted primitives are associated with these metadata.

4. The method of designation of a target as claimed in claim 3, further comprising presentation of a reference virtual image to an operator (step C).

5. The method of designation of a target as claimed in claim 4, wherein the presented image is the reference orthoimage and in that the step of designation of the target is carried out by the operator on this orthoimage and comprises a sub-step of centering the reference image in order to obtain a virtual orthoimage centered on this position.

6. The method of designation of a target as claimed in claim 4, wherein the presented image is the projected orthoimage and the step of designation of the position of the target comprises a sub-step of designation, by the operator, of the target in the image projected according to the viewing conditions of the optronic image in order to obtain a projected virtual image centered on this position, and a sub-step of transformation of this centered projected virtual image into a centered virtual orthoimage.

7. The method of designation of a target as claimed in claim 1, further comprising:
extraction of primitives from the acquired image, called acquired primitives (step F),
matching of the virtual primitives and the acquired primitives (step G),
enhancement of the virtual primitives by the acquired primitives and designation of the position of the target (step H).

8. An optronic target designation system equipped with an imager and connected to a weapon having terminal guidance via imaging, further comprising means of geolocation of the image acquired by the imager, a virtual images database and a processing unit capable of implementing the method as claimed in claim 1.
